(19) United States
(12) Patent Application Publication
(10) Pub. No.: US 2005/0207659 A1
(43) Pub. Date: Sep. 22, 2005

(54) Image-processing apparatus, program, and recording medium

(76) Inventor: Taku Kodama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/077,011

(22) Filed: Mar. 11, 2005

(30) Foreign Application Priority Data
Mar. 19, 2004 (JP) 2004-079995

(51) Int. Cl. G06K 9/36

(52) U.S. Cl. 382/232

(57) ABSTRACT

An image-processing apparatus for compressing and encoding image data so as to generate compressed image data is disclosed. The apparatus includes image-reading means for reading the image data; compression-processing means for compressing the image data which are read at the image-reading means and for generating header information and code data; data-position setting means for setting recording positions of at least one specific-information set out of the header information generated at the compression-processing means, the code data, at least one of image information sets or compression information sets included in the header information, and at least one packet configuring the code data; and code-configuring means for generating compressed data which are the specific information sets generated at the compression-processing means arranged depending on the recording positions set by the data-position setting means.

### TECHNICAL FIELD

The present invention generally relates to a technology for image processing, and more particularly to an apparatus for image processing, a program, and a recording medium.

### BACKGROUND ART

In an image-compression method such as represented by the JPEG 2000 compression method that has scalability with respect to at least one component out of position, a frequency component, a color component, and image quality, required data cannot be obtained at high speed with a related-art method of decompressing an image sequentially from the start of data.

Moreover, for conducting communications and editing, etc., of an image via the Internet, which has rapidly proliferated in recent years, it is necessary to extract at high speed only required components so as to process the extracted components.

Therefore, in order to fulfill these requirements, it is necessary to grasp which components of data exist at which positions within image data. Thus, in the related art, the image data are divided into fixed-length data sets so as to compress the divided data sets. For example, in Patent Document 1, a technology is described that sets data sets in wavelet-converted subbands to be fixed-length. More specifically, data sets which exceed a desired data size are truncated while data sets which are short of the desired data size have dummy data sets added, so that the respective data sizes for the subbands are adjusted.

Patent Document 1

JP2002-34043A

However, according to the technology as disclosed in the Patent Document 1, even for performing lossless compression, some data sets are discarded in order to set the data sets to be fixed-length, causing the compression to not be lossless. It is noted that a method is also possible such that, in order to maintain the losslessness, the respective amounts of the data sets are derived for each of the subbands and the data sets are adjusted to the largest size, so as to set the data sets to be fixed-length. In such a case as described above, the amount of dummy data sets increases so as to cause a significant reduction in the compression rate.

Moreover, the technology disclosed in the Patent Document 1 for setting the respective code lengths for the subbands does not take into account high-speed access of the data of the components other than the frequency component.

Furthermore, the technology disclosed in the Patent Document 1 is for adjusting the code lengths and not for determining the positions of codes within the image data including a header portion, etc.

### DISCLOSURE OF THE INVENTION

Accordingly, it is a general object of the present invention to provide a technology for image processing that substantially obviates one or more problems caused by the limitations and disadvantages of the related art.

It is a more particular object of the present invention to provide an apparatus for image processing, a program, and a recording medium that achieve an increased speed of accessing specific information sets and that arranges the desired specific information sets at the corresponding desired positions without causing a reduction in the compression rate.

According to the invention, an image-processing apparatus for compressing and encoding image data so as to generate compressed image data includes image-reading means for reading the image data; compression-processing means for compressing the image data which are read at the image-reading means and generating header information and code data; data-position setting means for setting recording positions of at least one specific-information set out of the header information generated at the compression-processing means, the code data, at least one of image information sets or compression information sets included in the header information, and at least one packet configuring the code data; and code-configuring means for generating compressed data which are the specific information sets generated at the compression-processing means arranged depending on the recording positions set by the data-position setting means.

The image-processing apparatus as described above achieves an increased speed of accessing specific information sets and arranges the desired specific information sets at the corresponding desired positions without causing a reduction in the compression rate.

### BRIEF DESCRIPTION OF THE DRAWINGS

Other objects, features, and advantages of the present invention will become more apparent from the following detailed description when read in conjunction with the accompanying drawings, in which:

FIG. 1 is a functional block diagram of a system implementing a hierarchical-coding algorithm to be a basis for a JPEG 2000 method on which the present invention is predicated;

FIG. 2 is a diagram for describing divided rectangular-shaped regions of each component of an original image;

FIG. 3 is a diagram for describing subbands in each of the decomposition levels, where the number of the decomposition levels is three;

FIG. 4 is a diagram for describing precincts;

FIG. 5 is a diagram for describing one example of a procedure for ranking bit planes;

FIG. 6 is a diagram for describing a schematic configuration for one frame of code-sequence data;

FIG. 7 is a diagram for describing a code-stream structure showing, for each subband, packets in which coded wavelet-coefficient values are held;

FIG. 8 is a schematic diagram illustrating a system-implementation example of a first embodiment of the present invention;

FIG. 9 is a diagram illustrating a modular configuration of a server computer as an image-processing apparatus;

FIG. 10 is a block diagram illustrating a functional configuration of the server computer;

FIG. 11A is a schematic diagram illustrating a data configuration of code data generated by the server computer;

FIG. 11B is a schematic diagram illustrating another data configuration of the code data generated by the server computer;

FIG. 11C is a schematic diagram illustrating yet another data configuration of the code data generated by the server computer;

FIG. 12A is a schematic diagram illustrating a method of adjusting a header position and adjusting information sets within a header;

FIG. 12B is a schematic diagram illustrating another method of adjusting the header position and adjusting the information sets within the header;

FIG. 12C is a schematic diagram illustrating yet another method of adjusting the header position and adjusting the information sets within the header;

FIG. 12D is a schematic diagram illustrating yet another method of adjusting the header position and adjusting the information sets within the header;

FIG. 13 is a block diagram illustrating a variation of the functional configuration of the server computer;

FIG. 14A is a schematic diagram illustrating a data configuration of code data generated by the server computer of a second embodiment of the present invention;

FIG. 14B is a schematic diagram illustrating another data configuration of the code data generated by the server computer of the second embodiment of the present invention;

FIG. 14C is a schematic diagram illustrating yet another data configuration of the code data generated by the server computer of the second embodiment of the present invention;

FIG. 15A is a schematic diagram illustrating a method of adjusting a code-data position, and adjusting a packet-data position;

FIG. 15B is a schematic diagram illustrating another method of adjusting the code-data position, and adjusting the packet-data position;

FIG. 15C is a schematic diagram illustrating yet another method of adjusting the code-data position, and adjusting the packet-data position;

FIG. 16 is a block diagram illustrating a functional configuration of the server computer of a third embodiment of the present invention;

FIG. 17 is a block diagram illustrating a variation of the functional configuration of the server computer;

FIG. 18 is a block diagram illustrating a functional configuration of the server computer of a fourth embodiment of the present invention;

FIG. 19 is a block diagram illustrating a functional configuration of the server computer of a fifth embodiment of the present invention; and

FIG. 20 is a block diagram illustrating a variation of the functional configuration of the server computer.

### BEST MODE FOR CARRYING OUT THE INVENTION

(Regarding JPEG 2000)

First, an overview of “a hierarchical-coding algorithm” and “a JPEG 2000 algorithm” which algorithms the present invention is predicated on is provided.

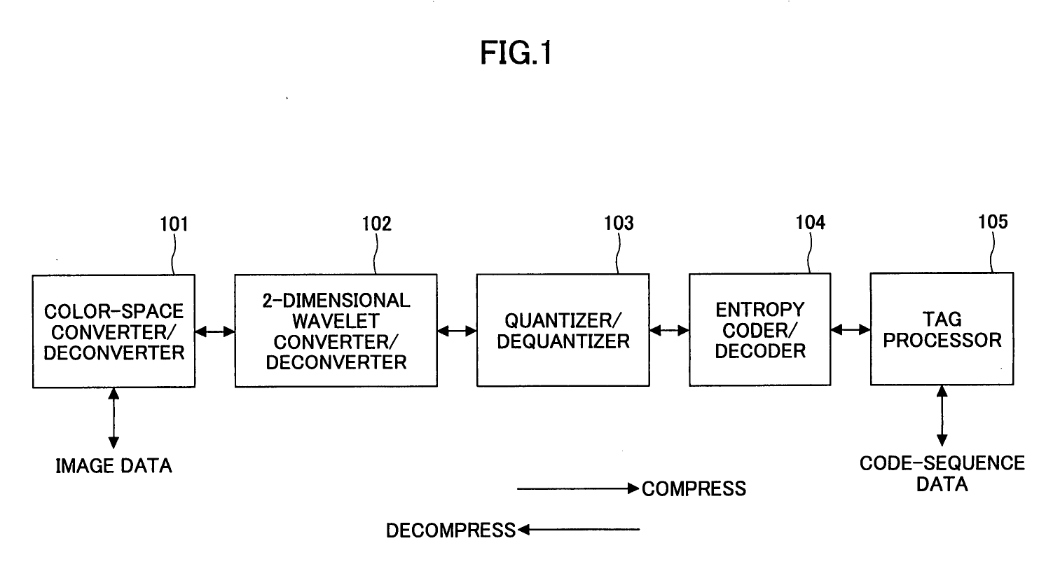

FIG. 1 is a functional block diagram of a system implementing the hierarchical-coding algorithm to be a basis for the JPEG 2000 method. This system consists of each of functional blocks of a color-space converter/deconverter 101, a two-dimensional wavelet converter/deconverter 102, a quantizer/dequantizer 103, an entropy encoder/decoder 104, and a tag processor 105.

One of the points in which this system differs most from a related-art JPEG algorithm is a conversion method. While a DCT (Discrete-Cosine Transform) is used in JPEG, a DWT (Discrete-Wavelet Transform) is used at the two-dimensional wavelet converter/deconverter 102 in this hierarchical-coding algorithm. The DWT has an advantage in that its image quality in a highly-compressed region is better than the image quality of the DCT, which is one major reason that the DWT is adopted in the JPEG 2000, an algorithm succeeding the JPEG.

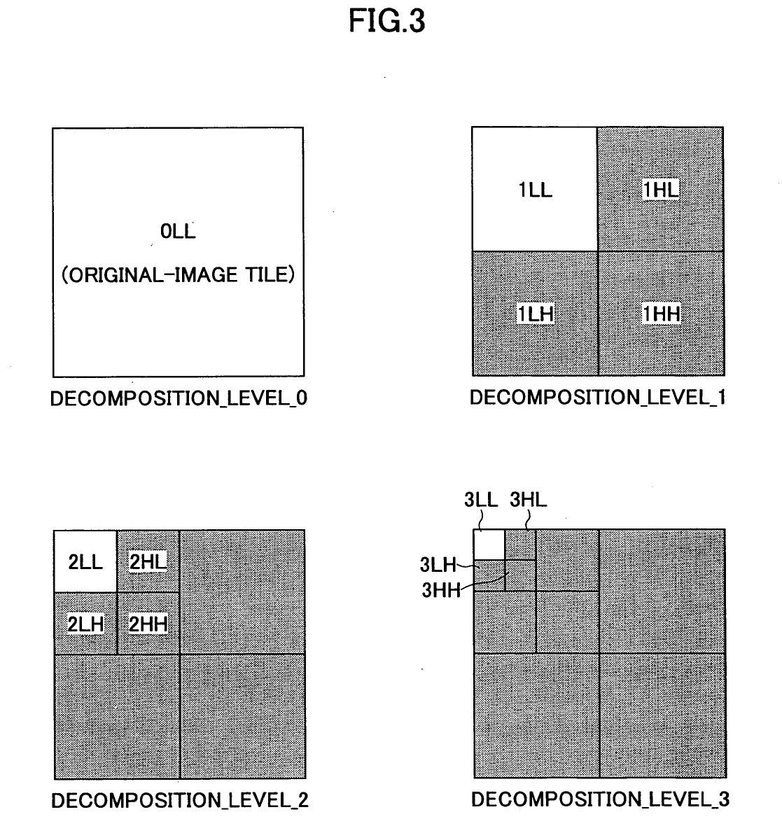

Moreover, another major difference is that, in this hierarchical-coding algorithm, a functional block of the tag processor 105 that is for code formation is added at the final stage of the system. In this tag processor 105, compressed data are generated as code-sequence data at the time of the image compression process, while code-sequence data required for decompression are interpreted at the time of the decompression process. Then, the code-sequence data allow the JPEG 2000 to be implemented for various useful functions. For example, the compression and decompression processes of a still image can be stopped freely at any hierarchical level (decomposition level) corresponding to octave divisions in the DWT which is block-based (refer to FIG. 3 as described below).

Often the color-space converter/deconverter 101 is connected to input or output portions of an original image. For example, corresponding to such portions as described above is a portion converting or deconverting a RGB color system, consisting of each component of a Red/Green/Blue primary-color system, or a YMC color system consisting of each component of a Yellow/Magenta/Cyan complementary-color system, into a YUV or YCbCr color system.

Next, the JPEG 2000 algorithm is described.

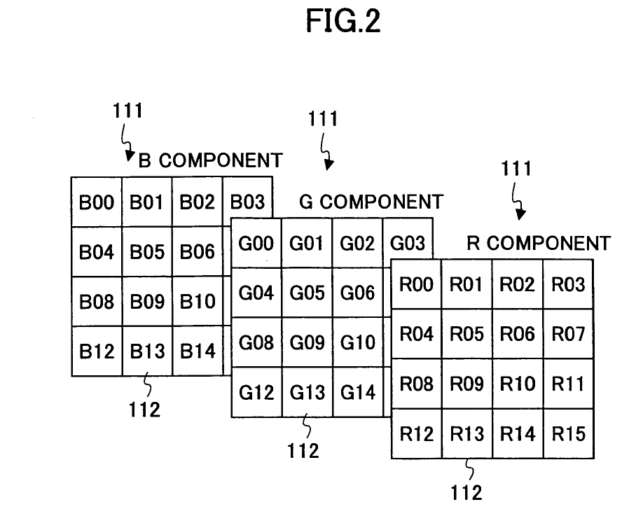

As illustrated in FIG. 2, for a color image, each of components 111 (a RGB primary-color system herein) of an original image is generally divided into rectangular-shaped regions. Such divided rectangular-shaped regions as described above, generally called blocks or tiles and generally called tiles in the JPEG 2000, are described below as tiles. In an example in FIG. 2, each of the components 111 is divided into 4 by 4, or a total of 16, rectangular-shaped tiles 112. Each of the tiles 112 (R00, R01, . . . ,R15/G00, G01, . . . ,G15/B00, . . . ,B15) becomes a basic unit for executing the compression/decompression process of the image data. Therefore, the process of the compression/decompression of the image data is performed independently for each of the components 111 or for each of the tiles 112.

At the time of encoding the image data, the data of each of the tiles 112 of each of the components 111 are input into the color-space converter/deconverter 101 in FIG. 1 and are color-space converted, after which the color-space converted data are two-dimensional wavelet-converted (forward converted) at the two-dimensional wavelet-converter 102 so as to be spatially divided into frequency bands.

FIG. 3 illustrates subbands in each of the decomposition levels for the number of decomposition levels of three. In other words, a tile original image (0LL) (a decomposition level 0) obtained by tile-dividing an original image is two-dimensional wavelet-converted so as to be divided into subbands (1LL, 1HL, 1LH, and 1HH) as illustrated for a decomposition level 1. Then the process proceeds such that a low-frequency component 1LL in this hierarchical level is two-dimensional wavelet-converted so that subbands (2LL, 2HL, 2LH, and 2HH) as illustrated for a decomposition level 2 are split off. The process proceeds in such a similar manner that a low-frequency component 2LL is also two-dimensional wavelet-converted so that subbands (3LL, 3HL, 3LH, and 3HH) as illustrated for a decomposition level 3 are split off. In FIG. 3, subbands to be encoded in the respective decomposition levels are shown shaded. For example, for the number of decomposition levels of 3, the subbands illustrated as shaded (3HL, 3LH, 3HH, 2HL, 2LH, 2HH, 1HL, 1LH, and 1HH) are to be encoded, while the 3LL subband is not to be encoded.

Next, bits to be encoded are specified in the order of the encoding designated so that a context is generated at the quantizer/dequantizer 103 as illustrated in FIG. 1 from bits in the vicinity of the bits to be encoded as described above.

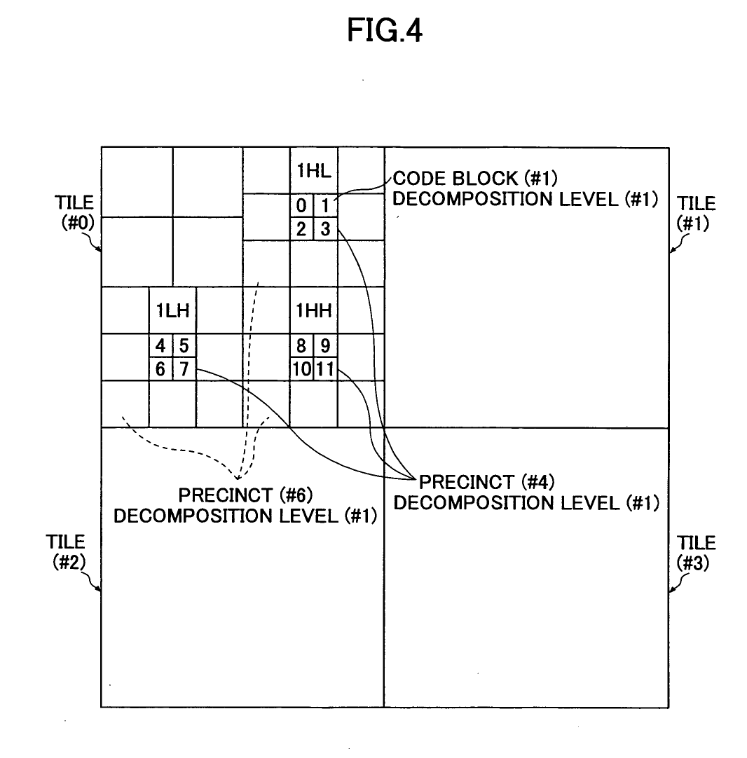

The wavelet coefficient which is quantized as described above is divided for each of the individual subbands into non-overlapping rectangles called “precincts”. The process as described above is introduced for implementing an efficient use of memory resources. As illustrated in FIG. 4, one precinct consists of three spatially-corresponding rectangular-shaped regions. Moreover, the individual precincts are divided into non-overlapping rectangular-shaped “code blocks”. Each of the code blocks become a basic unit for performing entropy encoding.

The wavelet-converted coefficient value which can be quantized and encoded without performing any process in JPEG 2000, can be decomposed into “bit planes” so as to rank the bit planes for each of the pixels or code blocks, in order to increase the encoding efficiency.

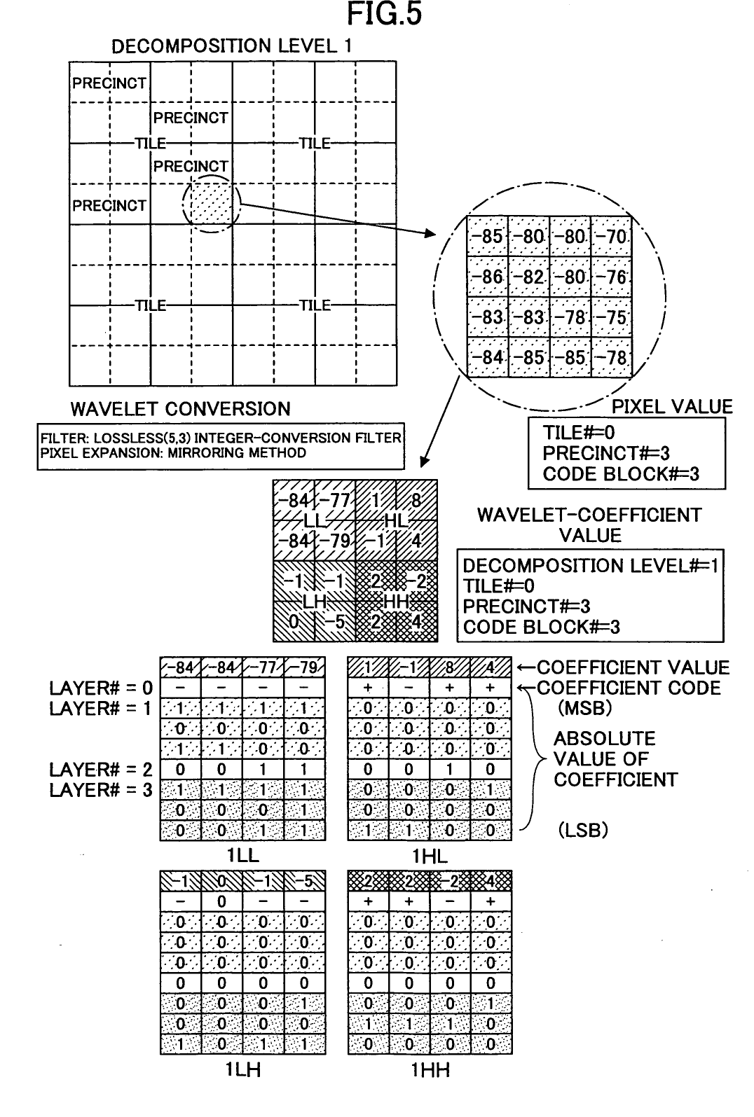

Here, FIG. 5 is a diagram for illustrating one example of a procedure for ranking the bit planes. As illustrated in FIG. 5, the illustrated example is a case of dividing an original image (32 by 32 pixels) into four tiles of 16 by 16 pixels with the respective sizes of the precinct and the code block of the decomposition level 1 of 8 by 8 pixels and 4 by 4 pixels. The precinct and code-block numbers are assigned in the order of raster scan so that, in this example, the precinct nembers of 0 through 3 and the code block numbers of 0 through 3 are assigned. A mirroring method is used for expanding pixels to outside a tile border, the wavelet conversion is performed with a lossless (5,3) filter, and a wavelet-coefficient value for the decomposition level 1 is derived.

Moreover, a diagram for describing one example of the concept of a representative “layer” configuration is also provided for a tile 0/a precinct 3/a code block 3. The converted code block is divided into subbands (1LL, 1HL, 1LH, and 1HH) so that wavelet-coefficient values are assigned to the respective subbands.

When the wavelet-coefficient values are seen in the horizontal direction (the bit-plane direction), it is easy to understand the layer structure. One layer consists of any number of bit planes. In this example, layers 0 through 3 consist of 1, 3, 1, and 3 bit planes, respectively. Then, a layer including a bit plane which is closer to the LSB (Least Significant Bit) is to be quantized earlier, and, to the contrary, a layer closer to the MSB (Most Significant Bit) is left unquantized until the end. The method of discarding from the layer closer to the LSB that is called truncation can minutely control the quantization rate.

At the entropy coder/decoder 104 as illustrated in FIG. 1, each of the tiles 112 of the components 111 is encoded with a probability estimation from the context and the target bit. Thus, the encoding process is performed per tiles 112 for all of the components of the original image. Finally, the tag processor 105 performs the process of joining all encoded data from the entropy coder/decoder 104 into one code-sequence data set as well as adding a tag to the one code-sequence data set.

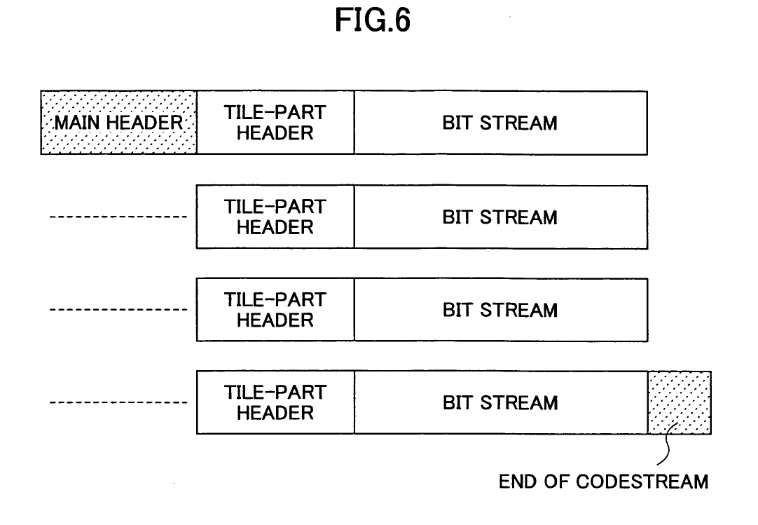

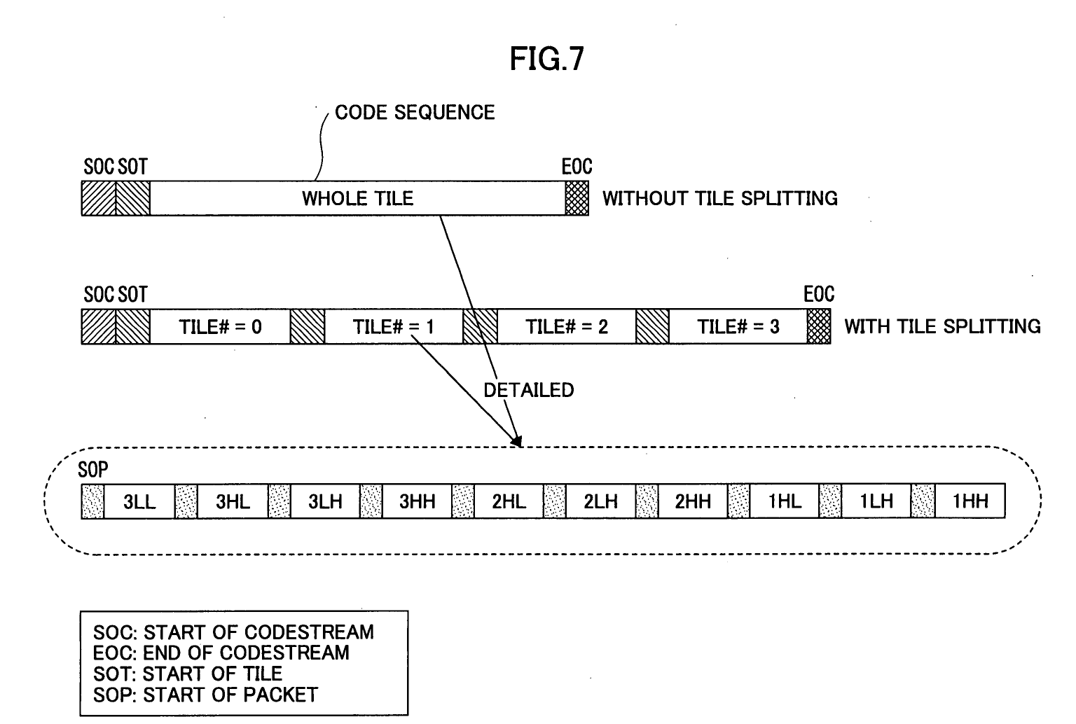

FIG. 6 illustrates a schematic configuration for one frame of such code-sequence data as described above. Tag-information sets called headers (a main header, and a tile-part header which is tile-border position information, etc.) are added at the beginning of the code-sequence data and at the beginning of the code data (a bit stream) of each tile, after which the code data of each tile follow. It is noted that coding parameters and quantizing parameters are provided in the main header. Then, at the end of the code-sequence data, a tag (an end of codestream) is placed again. Moreover, FIG. 7 illustrates a code-stream structure showing the respective subbands packets in which coded wavelet coefficient values are held. As illustrated in FIG. 7, performing or not whether performing the process of dividing according to tiles, the packet-sequence has the same structure.

On the other hand, for decoding the coded data, in reverse of the process of encoding the image data, the image data are generated from a code-sequence data set of each of the tiles 112 of each of the components 111. In such a case as described above, the tag processor 105 interprets tag information which is added to the code-sequence data set input from outside, decomposes the code-sequence data set of each of the tiles 112 of each of the components 111, and the decoding process (the decompression process) is performed for each of the code-sequence data sets of each of the tiles 112 of each of the components 111. Then, the position of the bit to be decoded is specified in the order based on the tag information within the code-sequence data set, and a context is generated at the quantizer/dequantizer 103 from the pattern of (already decoded) bits in the vicinity of the bit to be decoded as described above. At the entropy coder/decoder 104, a decoding is performed with a probability estimation from the context and bit-sequence data set, and the bit to be decoded is generated so as to write the generated bit to be decoded in the position for the bit to be decoded. Thus, the decoded data which are spatially divided per frequency band are two-dimensional wavelet-deconverted at the two-dimensional wavelet converter/deconverter 102 so that each of the tiles 112 of each of the components 111 of the image data is reconstructed. The reconstructed data are converted into image data of the original color system by the color-space converter/deconverter 101.

The above describes “the JPEG 2000 algorithm”.

### First Embodiment

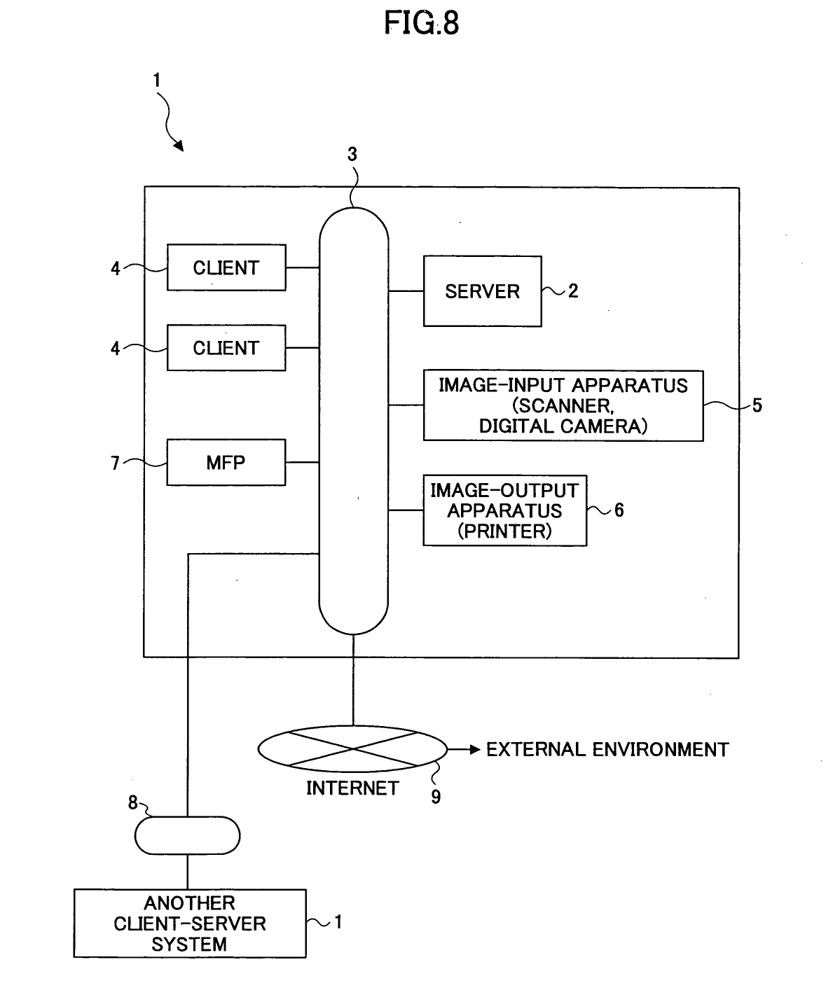

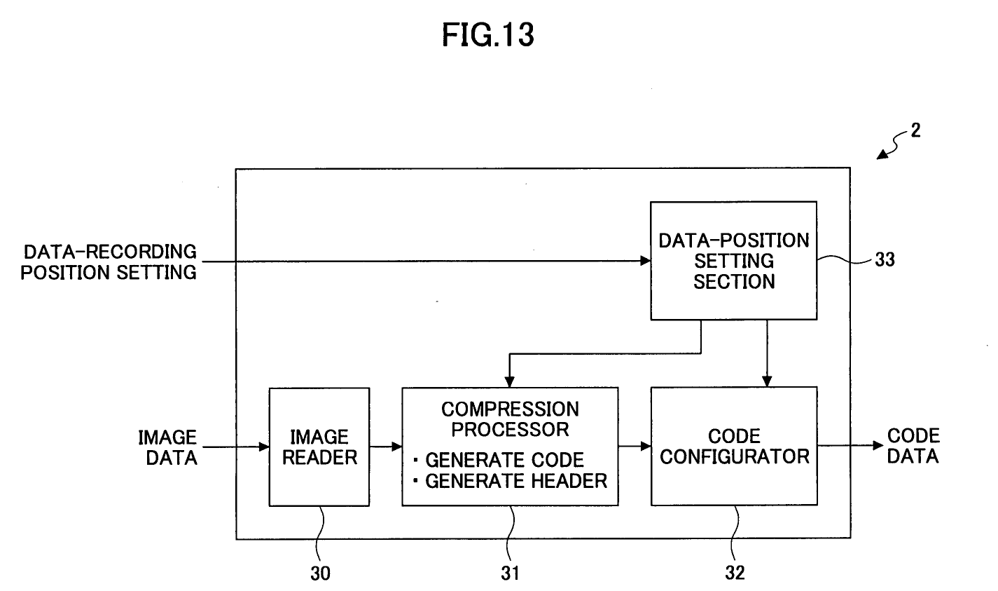

Below, a first embodiment of the present invention is described based on FIGS. 8 and 13. Here, it is noted that, while an example concerning a technology for compressing and decompressing images that is represented by JPEG 2000 is described, needless to say, the present invention is not limited to what is described below.

A server computer and a client computer of the present embodiment are operationally controlled by an image-processing program which is either installed on the computers as described above or interpreted so as to be executed, so that the image processing is executed. In the present embodiment, a storage medium for storing such image-processing program as described above is also introduced.

FIG. 8 is a schematic diagram illustrating a system-implementation example of the present embodiment.

In an image-data processing system of the present invention, a client-server system 1 is envisaged that has multiple client computers 4 connected via a network 3 such as a LAN (Local Area Network) to a server computer 2 which is an image-processing apparatus. Such client-server system 1 as described above is provided with an environment such that an image-input apparatus 5 such as a scanner or a digital camera, and an image-output apparatus 6 such as a printer may be shared on the network 3. Moreover, an environment may be provided such that a MFP 7 called a Multi-Functional Peripheral that is connected to the network 3 functions as an image-input apparatus 5 or an image-output apparatus 6.

Such client-server system 1 as described above is, for instance, implemented such as to make it possible to communicate data with another client-server system 1 via an intranet 8, for example, and is implemented such as to make it possible to communicate data with the external environment via the Internet 9.

The server computer 2 is roughly for saving code data so as to deliver the saved code data to the client computer 4.

Below, the server computer 2 which is an image -processing apparatus making full use of the characteristic features of the present invention is described.

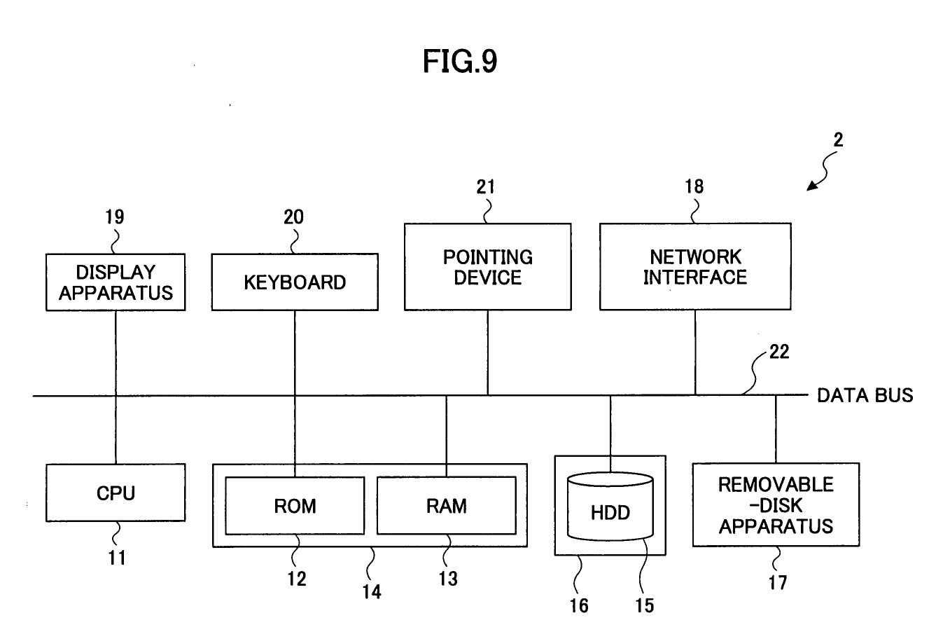

FIG. 9 is a diagram illustrating a modular configuration of the server computer 2 as an image-processing apparatus of: the present embodiment. The server computer consists of: a CPU (Central Processing Unit) 11 for processing information, memory apparatuses 14 such as a ROM (Read-Only Memory) 12 and a RAM (Random-Memory Memory) 13, secondary-storage apparatuses 16 such as a HDD (Hard-Disk Drive) 15 that are storage sections for storing compressed codes as described below, a removable-disk apparatus 17 such as a CD-ROM drive that is for storing information, distributing and obtaining information to and from the outside, a network interface 18 for transmitting information through communicating via the network 3 with the image-input apparatus 5 and other external computers, a display apparatus 19 such as a CRT (Cathode Ray Tube) or a LCD (Liquid Crystal Display) that is for displaying the progress and the outcome of the processing, etc., to the operator, a keyboard 20 for the operator to input into the CPU 11 instructions and information, etc., and a pointing device 21 such as a mouse, etc. The server computer 2 operates via a bus controller 22 which arbitrates data transmitted and received between each of the sections as described above.

In the server computer 2 as described above, when the user turns on the power, the CPU 11 activates a program called a loader within the ROM 12, and a program for managing the hardware and software of the computer that is called an operating system is read into the RAM 13 from the HDD 15, so that the operating system as described above is activated. Such operating system activates a program, and reads in and saves information in response to the user operations. Windows (a registered trademark) and UNIX (a registered trademark), etc., are known as representative operating systems. An operating program which runs on such operating system as described above is called an application program.

Here, the client computer 4 stores in the HDD an image-processing program as the application program. In such a context as described above, the HDD 15 acts as a storage medium for storing the image-processing program.

Moreover, generally, a processing program which is installed in such secondary-storage apparatuses 16 as the HDD 15 of the server computer 2 is recorded in an optical information recording medium such as a CD-ROM or a DVD-ROM, and in a magnetic medium such as a FD so that the processing program recorded is installed in such secondary-storage apparatuses 16 as the HDD 15. Thus, even the optical-information recording medium such as the CD-ROM, or a portable storage medium such as the FD may become a storage medium for storing the image-processing program. Moreover, the image-processing program may be taken in from the outside via the network interface 18, for example, so as to be installed in the secondary-storage apparatuses 16 such as the HDD 15.

In the server computer 2, when the image-processing program which runs on the operating system is activated, the CPU 11, in accordance with the image-processing program, executes various types of operational processes so as to centrally control each of the sections. The characteristic processes of the present embodiment out of the various operational processes which the CPU 11 of the server computer 2 execute are described below.

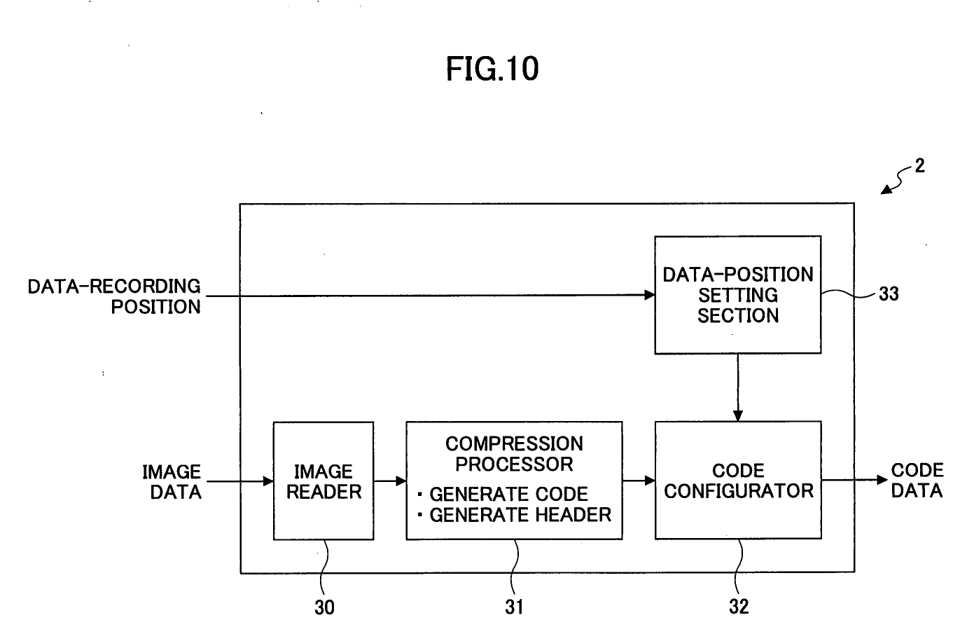

FIG. 10 is a block diagram illustrating a functional configuration of the server computer 2. As illustrated in FIG. 10, the server computer 2 comprises an image reader 30 which is image-reading means for reading image data, a compression processor 31 which is compression-processing means for compressing and encoding the image data to the JPEG 2000 standard, a code configurator 32 which is code-configuring means, and a data-position setting section 33 which is data-position setting means. In other words, roughly speaking, image data read at the image reader 30 are encoded and compressed at the compression processor 31 to the JPEG 2000 standard. More specifically, the process of compressing the image data is performed so that a header indicating image information and compression conditions, and code data are generated. While, at the following code configurator 32, the header and the code data are combined so as to generate compressed data, the data-position setting section 33 makes settings of specific information of the image for setting the data-recording position, and the data-recording position, so that the code configurator 32 arranges the code data and the header within the compressed data based on such settings as described above. In this case, the compressed image data: represent data compressed after undergoing the process of dividing according to at least one of dividing according to the position, dividing according to the frequency component, dividing according to the position after dividing according to the frequency component, dividing according to the color component, and dividing according to the image quality; and are data from which data of a specific position, frequency component, position after decomposing into the frequency component, color component, and image quality can be extracted, where the specific information as described above represents a combination of at least one of the components as described above. In other words, the data-position setting-section 33 records at the recording position which is set, data applicable to such combination of the components as described above from the specific information which is set. For example, a setting is possible such that, when the image is divided into rectangular-shaped regions, four centrally-positioned rectangles are recorded in n3 bytes starting from the start of the compressed data. Moreover, a setting is possible such that, where the codes divided into frequency components are set to be DL1 and DH1, respectively, data DL1 are recorded in nDL1 bytes starting from the start and data DH1 are recorded in nDHl bytes starting from the start.

Furthermore, the specific image information as described above represents at least one of the headers within the compressed data or at least one of the image information sets which are provided within the headers as described above. Parameters such as the tile, the decomposition level, the component, the precinct, the code block, and the layer that are specified in the JPEG 2000 specifications can be set so as to record a layer L₀ of a precinct P₁ of a component C₁ of a decomposition level D₁ of a tile T₁ in a position n4.

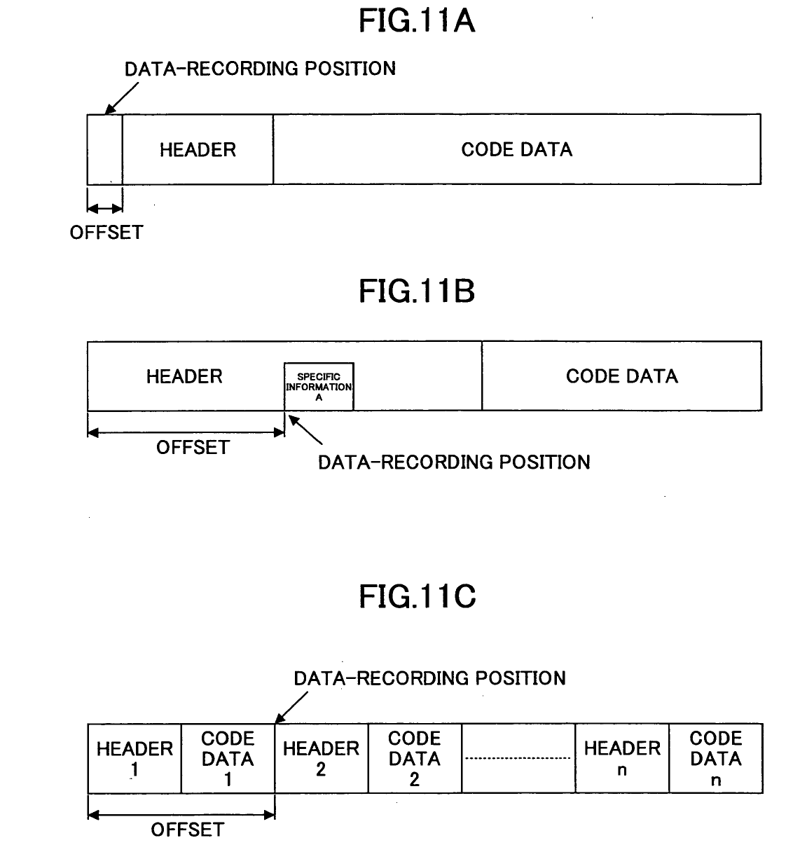

Now, code data generated by the server computer 2 are described. While the image data consist of the header and the code data, the code data generated by implementing the present method are provided with a header at the data-recording position which is set by the data-position setting section 33. Hereby, header information can be recorded at a predetermined position within the code data so as to make it possible to obtain desired data at high speed at the time of accessing data. Moreover, as illustrated in FIG. 11B, it is also possible to provide, at the data recording position which is set at the data-position setting section 33, specific information provided in the header information. Hereby, the specific information provided in the header information can be recorded at the predetermined position within the code data so as to make it possible to obtain required information at high speed as the reading position of the specific information is always set to be fixed. Moreover, the code data generated by implementing the present method, as illustrated in FIG. 1C, which may include multiple header information sets and multiple code data sets depending on the compression format, can also be used for setting the position of the specific header information.

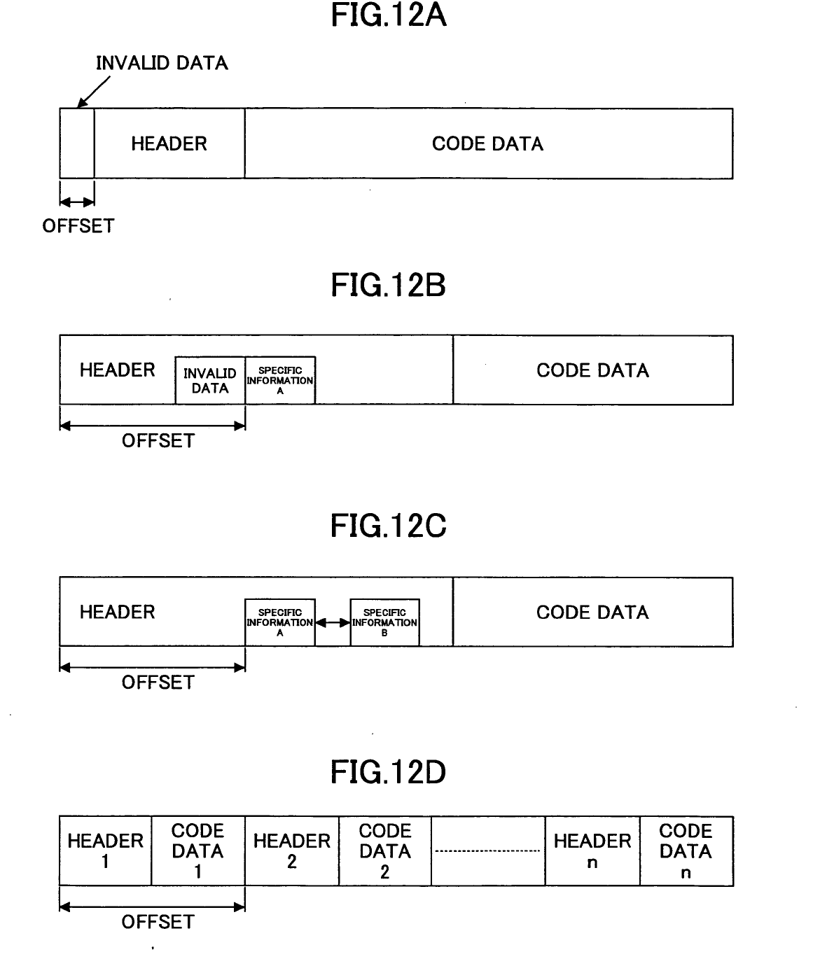

More specifically, adjusting a header position, and adjusting information within a header: as illustrated in FIGS. 12A and 12B, may be implemented by inserting invalid data; as illustrated in FIG. 12C, may be implemented by changing the order of arranging multiple information sets which are provided in the header; and furthermore, as illustrated in FIG. 12D, may be implemented by changing the sequential order of the header and the code data.

A method of setting the header position at the data-position setting section 33 can be setting the header position accurately in a certain number of bytes from the start of data. In this case, the position for recording the specific information can be restricted completely so as to make it possible to access the specific information at high speed. Moreover, setting at a position of a multiple of a certain numerical value such as to arrange the header position at a 4-byte border, which is commonly used in a PC, is also possible. In this case, the size of memory accessible by a PC and a HDD, etc., may be set as a border so that desired data are always arranged at the certain border, making it possible to access the data at high speed. Moreover, setting is also possible such as to record between N1 bytes from the start and N2 bytes from the start. In this case, the position at which the specific information set is recorded is restricted within a certain range so as to again make it possible to access the specific information set at high speed.

Hereby, header information or specific information sets included in the header information can be recorded at any position within compressed data so as to make it possible to achieve an increased speed of accessing the specific information sets. Moreover, recording specific information sets at any position within compressed data is implemented by changing the sequential order of the specific information sets, so as to make it possible also to arrange the desired specific information sets at the desired positions, without leading to a reduced compression rate, as there is no need to add dummy data within the compressed data.

It is noted that, in the present embodiment, while recording positions of specific information sets are all described as settings of the sizes from the start of data, it is also possible as a matter of course, with the use of the process of the present invention, to set the positions of the specific information sets as positions relative to other specific information sets.

Moreover, as illustrated in FIG. 13, for compressing and encoding the image data at the compression processor 31 to the JPEG 2000 standard, the data-position setting section 33 may make settings of specific information sets of image data for setting the data-recording positions, and set the data-recording positions, so as to set the specific information sets of the image data and the recording positions of the specific information sets into be recorded in the header information. Hereby, specific information sets of image data and recording positions of the specific information sets are recorded in header information so that an image-processing apparatus using the image data can easily confirm, based on such information sets recorded in the header, the positions at which the specific information sets are recorded, making it possible to flexibly configure image-compressed data without a need for an apparatus generating data and an apparatus using the data to communicate with each other all the time concerning a fixed position.

### Second Embodiment

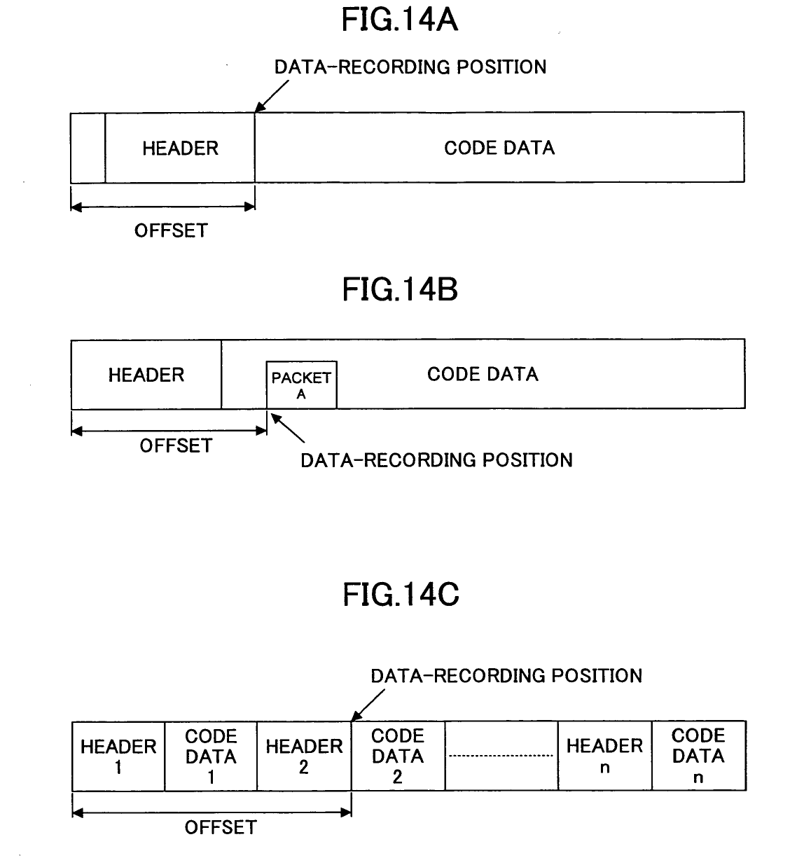

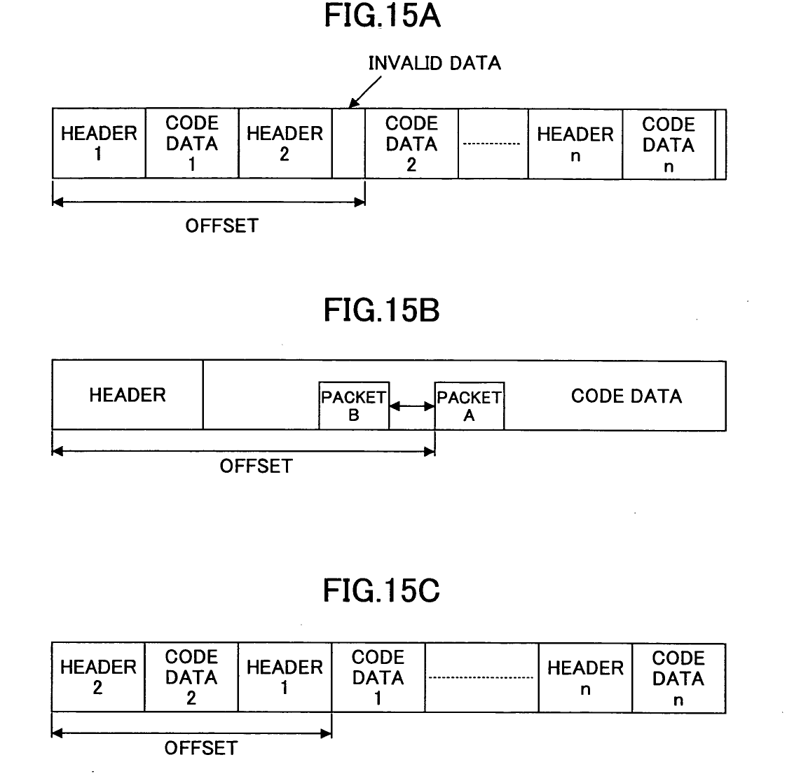

Below a second embodiment of the present invention is described based on FIGS. 14 and 15. It is noted that the same parts as in the first embodiment as described above are represented with the same letters so that the explanations are omitted. (The same applies for the subsequent embodiments.) The present embodiment differs from the first embodiment as described above in the specific image information in which the data-recording position is set by the data-position setting section 33.

The specific information of the image in the present embodiment represents at least one of code-data sets within the compressed data, decompressible compressed data such as at least one packet configuring the code data, or compressed data consisting of a collection of multiple packets (or a packet as described below).

Now, code data generated by the server computer 2 are described. While the image data consist of the header and the code data, the code data generated by implementing the present method, as illustrated in FIG. 14A, are provided at the data-recording position which is set at the data-position setting section 33. Hereby, it is made possible to obtain desired data at high speed at the time of accessing the code data. Moreover, as illustrated in FIG. 14B, it is also possible to provide, at the data recording position which is set at the data-position setting section 33, a specific packet (a packet A) of the code data. Hereby, the packet A is recorded at the set position as described above so as to make it possible to obtain required information at high speed as the reading position of the specific information is always set to be fixed. Moreover, the code data generated by implementing the present method, as illustrated in FIG. 14C, which may include multiple code data sets and multiple packets depending on the compression format, can also be used for setting the positions of the specific code and packet for such a case as described above.

More specifically, adjusting a code-data position, and adjusting a packet-data position: as illustrated in FIGS. 15A, may be implemented by inserting invalid data; as illustrated in FIG. 15B, may be implemented by changing the sequential order of packets within the coded data; and furthermore, as illustrated in FIG. 15C, may be implemented by changing the sequential order of the code data sets.

A method of setting the code position at the data-position setting section 33 can be setting the code position accurately in a certain number of bytes from the start of data. In this case, the position for recording the specific information can be restricted completely so as to make it possible to access the specific information at high speed. Moreover, setting at a position of a multiple of a certain numerical value such as to arrange the code position at a 4-byte border which is commonly used in a PC is also possible. In this case, the size of memory accessible by a PC and a HDD, etc., may be set as a border so that desired data are always arranged at the certain border, making it possible to access at high speed. Moreover, setting is also possible such as to record within the range between N1 bytes from the start and N2 bytes from the start. In this case, the position in which the specific information set is recorded is restricted within a certain range so as to again make it possible to access the specific information at high speed.

It is noted that, in the present embodiment, while recording positions of specific information sets are all described as settings of the sizes from the start of data, it is also easily possible as a matter of course, with the use of the process of the present invention, to set the positions of the specific information sets as positions relative to other specific information sets.

### Third Embodiment

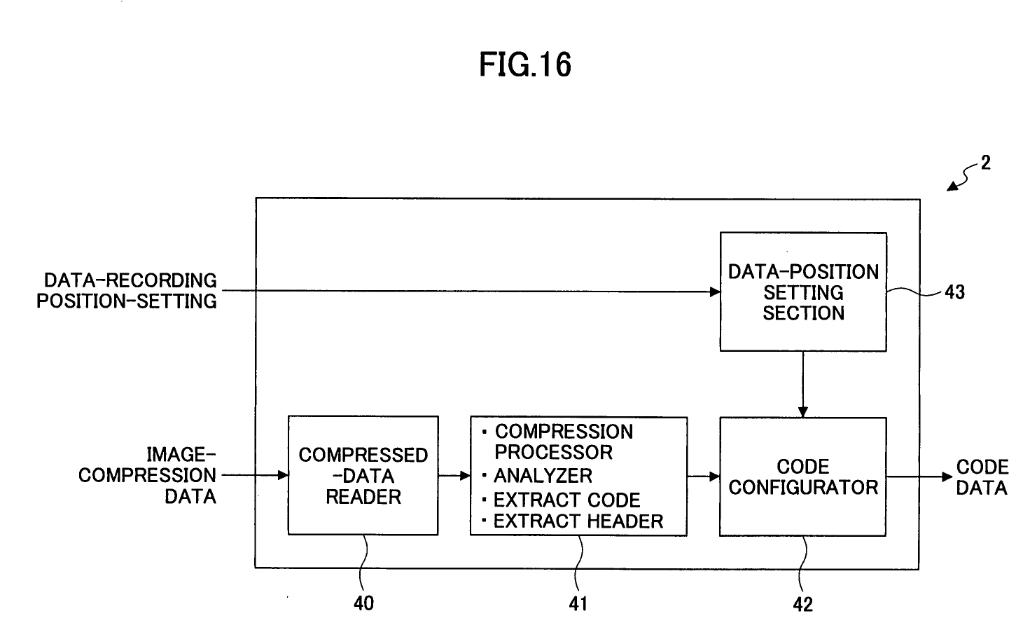

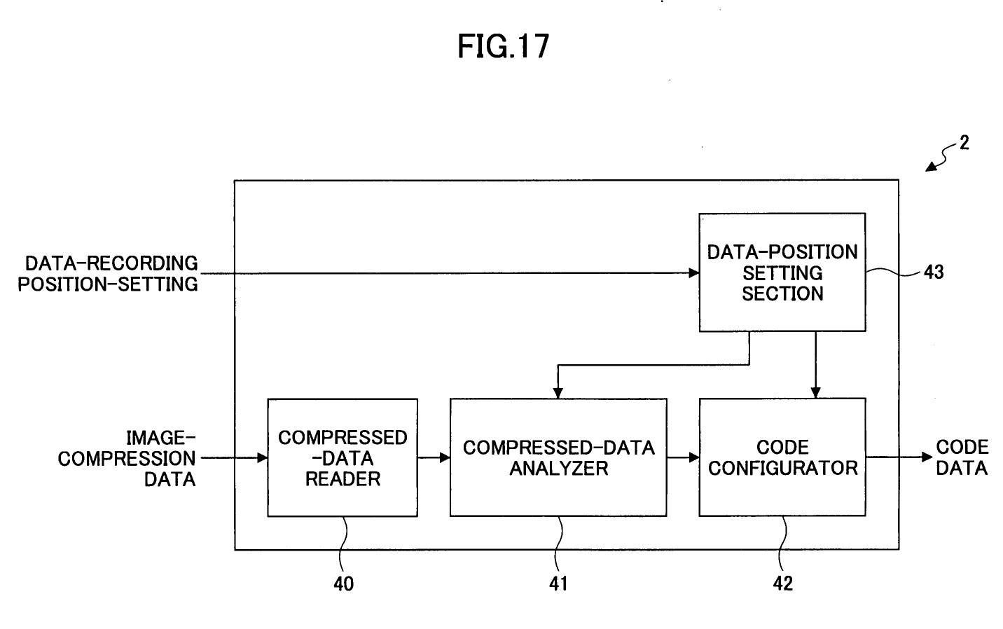

Below a third embodiment of the present invention is described based on FIGS. 16 and 17. The present embodiment differs from the first embodiment as described above in the functional configuration of the server computer 2.

FIG. 16 is a block diagram illustrating a functional configuration of the server computer 2. As illustrated in FIG. 16, the server computer 2 comprises a compressed-data reader 40 which is compressed-data reading means for reading compressed-image data, a compressed-data analyzer 41 which is compressed-data analyzing means for analyzing compressed-image data, a code configurator 42 which is code-configuring means, and a data-position setting section 43 which is data-position setting means. In other words, roughly speaking, compressed-image data read at the compressed-image reader 40 are analyzed at the compressed-image analyzer 41. More specifically, a process of analyzing compressed-image data is performed so that a header indicating image information and compression conditions, and code data are extracted. While, at the following code configurator 42, the header and the code data are combined so as to generate compressed data, the data-position setting section 43 makes settings of the specific image information for setting the data-recording position, and the data-recording position, so that the code configurator 42 arranges the code data and the header within the compressed data based on the settings as described above. Here, the specific information of the image represents at least one header within the compressed data or one of the image information sets provided within the header.

Here, the code data generated by the server computer 2 is no different from the code data described with reference to FIGS. 11 and 12 of the first embodiment so that the explanations are omitted.

Hereby, the header information, or the specific information included in the header information can be recorded at any position within the compressed data so as make it possible to access the specific information at high speed. Moreover, recording specific information sets at any positions within compressed data is implemented by changing the sequential order of the specific information sets, so as to make it possible also to arrange the desired specific information sets at the desired positions, without leading to a reduced compression rate, as there is no need to add dummy data within the compressed data.

It is noted that, while the specific information of the image is described as representing at least one header within the compressed data or at least one image information set provided within the header, it is not limited to such information sets as described above. For example, the specific information of the image may represent at least one code-data set within the compressed data, or decompressible compressed data such as at least one packet configuring the code data, or compressed data consisting of a collection of multiple packets (a packet as described below). In this case, the code data generated by the server computer 2 is no different from the code data described in the second embodiment with reference to FIGS. 14 and 15 so that the explanations are omitted.

Moreover, as illustrated in FIG. 17, for performing the process of analyzing the compressed-image data at the compressed-data analyzer 41, setting of specific information of image data for setting the recording position and the data-recording position may be obtained from the data-position setting section 43, so as to derive the reading position within the compressed data, read out the data from the recording position, and perform the process of analyzing the compressed image data. Hereby, specific information of image data and a recording position of the specific information are recorded in a header so that an image-processing apparatus using the image data can easily confirm, based on such information recorded in the header, the position at which the specific information is recorded, making it possible to flexibly configure image-compressed data without the need for an apparatus generating data and an apparatus using the data to communicate with each other all the time concerning a fixed position.

### Fourth Embodiment

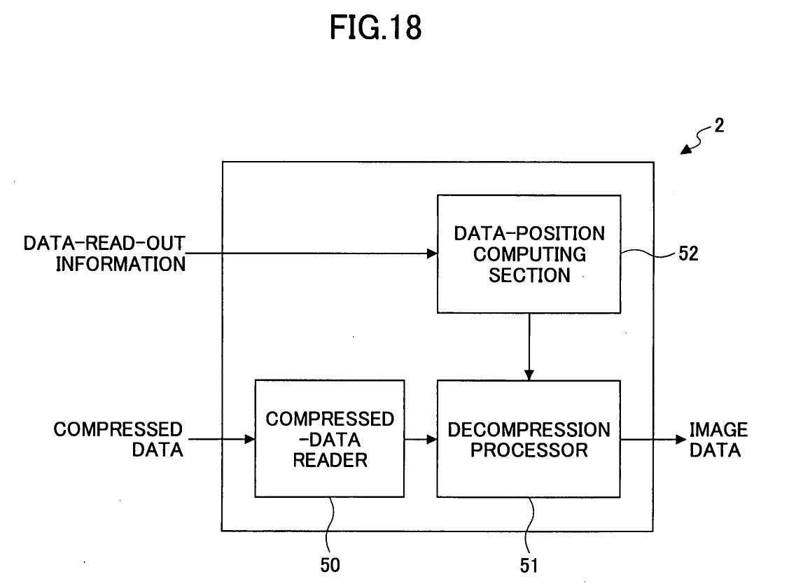

Below a fourth embodiment of the present invention is described based on FIG. 18. The present embodiment differs from the first embodiment as described above in the functional configuration of the server computer 2.

FIG. 18 is a block diagram illustrating a functional configuration of the server computer 2. As illustrated in FIG. 18, the server computer 2 comprises a compressed-data reader 50 which is compressed-data reading means for reading compressed-image data, a decompression processor 51 which performs the process of data decompression, and a data-position computing section 52 which is data-position computing means. In other words, roughly speaking, compressed-image data read at the compressed-image reader 50 are decompressed at the decompression processor 51. More specifically, the recording position of data of specific information of the image is computed by the data-position computing section 52 and the reading position within the compressed data is derived so that the data are read out from the recording position and undergo decompression for generating the image data. Here, the specific information of the image represents at least one header within the compressed data or at least one of the image information sets provided within the header.

Hereby, it is possible to obtain the recording position of any specific information so that, for example, based on the obtained outcome, a header is read out at high speed from the recording position of the header information for accessing the image information at high speed. Moreover, it is possible to obtain the recording position of any code data needed so that, based on the obtained outcome, an image of a specific region is decompressed at high speed.

### Fifth Embodiment

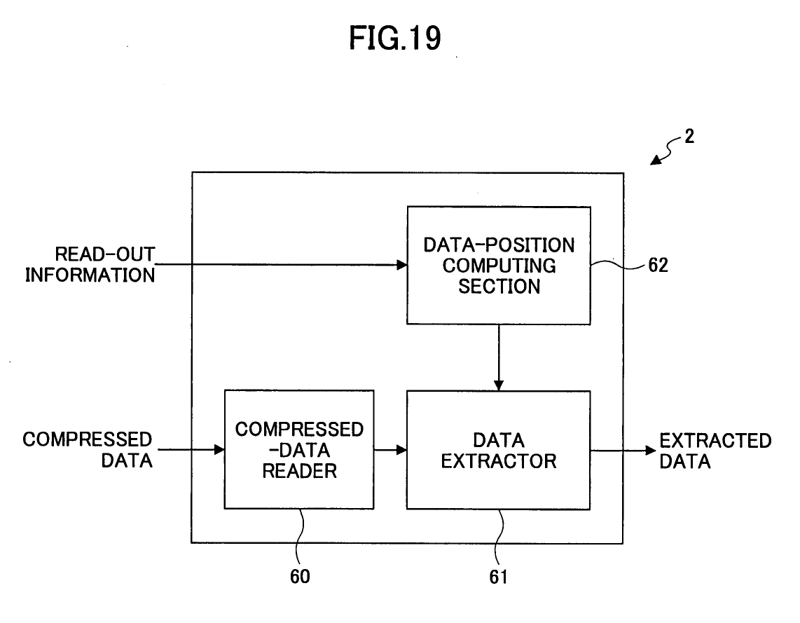

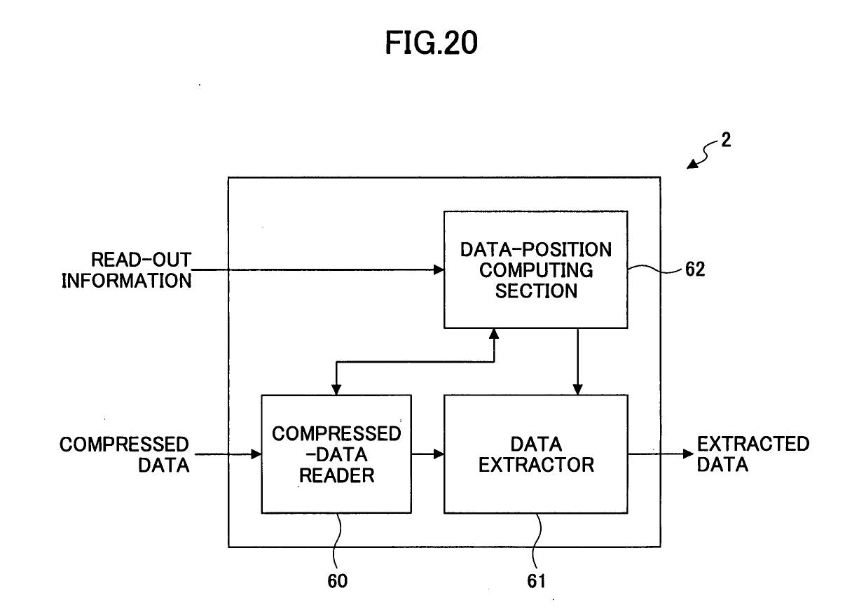

Below a fifth embodiment of the present invention is described based on FIGS. 19 and 20. The present embodiment differs from the first embodiment as described above in the functional configuration of the server computer 2.

FIG. 19 is a block diagram illustrating a functional configuration of the server computer 2. As illustrated in FIG. 19, the server computer 2 comprises a compressed-data reader 60 which is compressed-data reading means for reading compressed-image data, a data extracter 61 which is data extracting means for performing the process of extracting data, and a data-position computing section 62 which is data-position computing means. In other words, roughly speaking, the compressed-image data read into the compressed-data reader 60 undergoes the process of extracting data at the data extractor 61. More specifically, the recording position of data of specific information of the image is computed at the data-position computing section 62 and the reading position within the compressed data is derived so that the data are read from the recording position at the data extractor 61 for extracting the data. In this case, the compressed image data: represent data which are compressed after having been divided according to at least one of dividing according to the position, dividing according to the frequency component, dividing according to the position after dividing according to the frequency component, dividing according to the color component, and dividing according to the image quality; are data from which data of a specific position, frequency component, position after decomposing into the frequency component, color component, and image quality can be extracted, where the specific information as described above represents a combination of at least one of these components. In other words, the data-position computing-section 62 computes the recording position of data applicable to such combination of the components as described above from the specific information which is set. For example, when the image is divided into rectangular-shaped regions, the recording positions of four centrally-positioned rectangles can be obtained to process at high speed the four centrally-positioned regions. Moreover, when the codes divided into frequency components are set to be DL1 and DH1, respectively, the respective recording positions may be obtained to extract at high speed only the specific frequency components.

Here, the specific image information as described above represents at least one of the headers within the compressed data. Hereby, the recording position of any specific information needed can be obtained so that, based on the outcome, for example, the header is read out at high speed from the recording position of the header information to obtain the image information at high speed.

Moreover, when the specific image information as described above represents at least one of the image information sets which are provided within the headers as described above, the recording position of any specific information needed can be obtained so that, based on the outcome, for example, the image information is read out at high speed from the recording position of the specific information within the header to obtain the image information at high speed.

Furthermore, the specific image information may represent at least one code-data set with the compressed data or decompressible compressed data such as at least one packet configuring the code data, or compressed data consisting of a collection of multiple packets (a packet as described below). Hereby, the recording position of any specific information needed can be obtained so that, based on the outcome, for example, the codes of only the regions needed are obtained at high speed, as obtaining the code of any specific position is possible.

For example, as the specific information, parameters such as the tile, the decomposition level, the component, the precinct, the code block, and the layer that are specified in the JPEG 2000 specifications can be set so as to extract the position of a layer L₀ of a precinct P₁ of a component C₁ of a decomposition level D₁ of a tile T1.

It is noted that, as illustrated in FIG. 20, for reading the compressed image data at the compressed-data reader 60, the recording position of the specific information of the image for setting the data-recording position may be computed at the data-position computing section 62 so as to read the compressed data at the recording position. Hereby, specific information of image data and a recording position of the specific information are recorded in the header so that an image-processing apparatus using the image data can easily confirm, based on such information recorded in the header, the position at which the specific information is recorded, making it possible to flexibly configure image-compressed data without an apparatus generating data and an apparatus using the data having to communicate with each other all the time concerning a fixed position.

The present application is based on the Japanese Priority Application No. 2004-079995 filed on Mar. 19, 2004, the entire contents of which are hereby incorporated by reference.

1. An image-processing apparatus for compressing and encoding image data so as to generate compressed image data, comprising:
image-reading means for reading said image data;
compression-processing means for compressing said image data which are read at the image-reading means and generating header information and code data;
data-position setting means for setting recording positions of one or a plurality of specific-information sets out of said header information generated at the compression-processing means, said code data, one or a plurality of image information sets or compression information sets included in said header information, and one or a plurality of packets configuring said code data; and
code-configuring means for generating compressed data which are said specific information sets generated at said compression-processing means arranged depending on the recording positions set by said data-position setting means.

2. The image-processing apparatus as claimed in claim 1,
wherein the compression-processing means records into the header information, said specific-information sets and the data recording positions of said specific information sets that are set according to said data-position setting means.

3. The image-processing apparatus as claimed in claim 1,
wherein said code data generated at said compression-processing means consist of codes classified according to one or a plurality of a position, a frequency component, a color component, and image quality.

4. The image-processing apparatus as claimed in claim 1,
wherein said code data generated at said compression-processing means are codes compressed to a JPEG 2000 standard.

5. An image-processing apparatus for converting compressed data, comprising:
compressed-data reading means for reading said compressed data;
compressed-data analyzing means for analyzing said compressed data which are read at the compressed-data reading means and extracting header information and code data;
data-position setting means for setting recording positions of one or a plurality of specific-information sets out of said header information extracted at the compressed-data reading means, said code data, one or a plurality of image information sets and compression information sets included in said header information, and one or a plurality of packets configuring said code data; and
code-configuring means for generating compressed data which are said specific information sets extracted at said compressed-data analyzing means arranged depending on the recording positions set by said data-position setting means.

6. The image-processing apparatus as claimed in claim 5,
wherein the compressed-data analyzing means obtains said specific-information sets and the data recording positions of the specific-information sets, derives reading positions within said compressed data, reads data from the reading positions, and analyzes said compressed data.

7. The image-processing apparatus as claimed in claim 5,
wherein said code data extracted at said compressed-data analyzing means consist of codes classified according to one or a plurality of a position, a frequency component, a color component, and image quality.

8. The image-processing apparatus as claimed in claim 5,
wherein said code data extracted at said compressed-data analyzing means are codes compressed to a JPEG 2000 standard.

9. An image-processing apparatus for decompressing compressed data, comprising:
compressed-data reading means for reading said compressed data;
data-position computing means for computing reading positions with respect to one or a plurality of specific-information sets out of header information included in said compressed data read at the compressed-data reading means, code data, one or a plurality of image information sets and compression information sets included in said header information, and one or a plurality of packets configuring said code data; and
decompression-processing means for reading said specific information sets from said compressed data read at the compressed-data reading means depending on the reading positions computed by said data-position computing means and administering a decompression process so as to generate image data.

10. An image-processing apparatus for extracting data from compressed data, comprising:
compressed-data reading means for reading said compressed data;
data-position computing means for computing reading positions with respect to one or a plurality of specific-information sets out of header information included in said compressed data read at the compressed-data reading means, code data, one or a plurality of image information sets and compression information sets included in said header information, and one or a plurality of packets configuring said code data; and
data extracting means for reading said specific information sets from said compressed data read at the compressed-data reading means depending on the reading positions computed by said data-position computing means and extracting said specific information sets.

11. The image-processing apparatus as claimed in claim 10,
wherein said compressed-data reading means computes said specific-information sets and the data recording positions of the specific-information sets by said data-position computing means, and reads said compressed data at the recording positions.

12. The image-processing apparatus as claimed in claim 11,
wherein said compressed data read at said compressed-data reading means consist of codes classified according to one or a plurality of a position, a frequency component, a color component, and image quality.

13. The image-processing apparatus as claimed in claim 9,
wherein said compressed data read at said compressed-data reading means are codes compressed to a JPEG 2000 standard.

14. A program for causing a computer to execute the function of each of the means in the image-processing apparatus as claimed in claim 1, the computer configuring said image-processing apparatus.

15. A computer-readable storage medium,
wherein the program as claimed in claim 14 is stored.
